(19) United States
(12) Patent Application Publication
(10) Pub. No.: US 2017/0364835 A1
(43) Pub. Date: Dec. 21, 2017

(54) ONLINE RESERVATION SYSTEM FOR OPEN DECK CHAIRS

(71) Applicants: Bliss BAKER, Toronto (CA); Meredith PIERCE, Toronto (CA); Chris MIHALICZ, Toronto (CA)

(72) Inventors: Bliss BAKER, Toronto (CA); Meredith PIERCE, Toronto (CA); Chris MIHALICZ, Toronto (CA)

(21) Appl. No.: 15/183,408

(22) Filed: Jun. 15, 2016

(51) Int. Cl. G06Q 10/02; H04L 29/06

(52) U.S. Cl. CPC G06Q 10/02; H04L 63/102

(57) ABSTRACT

A method for determining a reservation booking of a chair location positioned in an outdoor environment, the method implemented by a computer processor operating on a set of instructions stored in memory to: receive a reservation request from a user over a communication network, the reservation request including a unique identifier for an establishment providing the outdoor environment and a reservation date/time; send a map of the outdoor environment over the communication network including a plurality of chair locations, each chair of the plurality of chairs having a respective indicator indicating whether said each chair is available or booked for the reservation time, the map including exterior features of the outdoor environment positioned in relation to the plurality of chair locations; receive a selection over the communication network of a desired chair location displayed on the map, the desired chair selected from the plurality of chair locations, and send the reservation booking over a communication network to the user, the reservation booking including a chair location identifier for the reservation time.

### FIELD

The present invention is related to reservation of seating in outdoor spaces.

### BACKGROUND

Outdoor public seating and table spaces allow people to do things over temporary durations, typically during their leisure time or vacation time. The way people currently handle present leisure/vacation seating, say at a beach or pool side, is to simply occupy whatever open seat might be available at the time they would need a seat. However, this is a problem for many people, businesses, and others because it results in people often going unseated due to unexpected people volumes at different times of the day, or otherwise being seated at locations that are unsuitable or otherwise preferred by the person. In addition, some people can occupy a defined seat and/or outdoor space for an inordinately long duration while other people pass by without the ability to sit.

To overcome this problem, some businesses and consumer-friendly locations have instituted reserved seating. When a person reserves a seat, he or she indicates a time the seat is needed. Then when the time arrives, the person can check in to guarantee that the seat reservation will be honored. However, current check-in systems do not provide a person adequate flexibility to accommodate for specific seating requirements in outdoor environments. As such, many known check-in systems can operate on a first-come, first-served basis whereby the person can be sure to get a seat after making a reservation, but the seat might be in an undesirable location. Moreover, current check-in systems generally do not allow the person to reserve the seat for a specific period of time. Therefore, seats may still be occupied for long durations, and collaborative seating arrangements can be difficult to organize, especially in view of outdoor variability in seating environments near pools and/or beach fronts.

### BRIEF DESCRIPTION OF THE DRAWINGS

Exemplary embodiments of the invention will now be described in conjunction with the following drawings, by way of example only, in which:

FIG. 1 is a block diagram of components of a seat reservation system;

FIG. 2 is a block diagram of an example device for the system of FIG. 2;

FIG. 3 is an example configuration of a representation generated by the system of FIG. 1; and

FIG. 4 is an example representation including sun/shade selection.

### SUMMARY

What is needed is a system that alleviates or otherwise mitigates at least one of shortcomings of the prior art to provide customized reservation options for outdoor seating and provide that existing seat inventory of an establishment can be put to the best possible use. Such a system can address simplicity and ease of use, both for the proprietor of the establishment owning the seats, and for those people desiring to reserve and use the outdoor seating.

A first aspect provided is a method for determining a reservation booking of a chair location positioned in an outdoor environment, the method implemented by a computer processor operating on a set of instructions stored in memory to: receive a reservation request from a user over a communication network, the reservation request including a unique identifier for an establishment providing the outdoor environment and a reservation date/time; send a map of the outdoor environment over the communication network including a plurality of chair locations, each chair of the plurality of chairs having a respective indicator indicating whether said each chair is available or booked for the reservation time, the map including exterior features of the outdoor environment positioned in relation to the plurality of chair locations; receive a selection over the communication network of a desired chair location displayed on the map, the desired chair selected from the plurality of chair locations, and send the reservation booking over a communication network to the user, the reservation booking including a chair location identifier for the reservation time.

### DESCRIPTION

### Definitions

For purposes of the description provided herein, the following definitions are used:

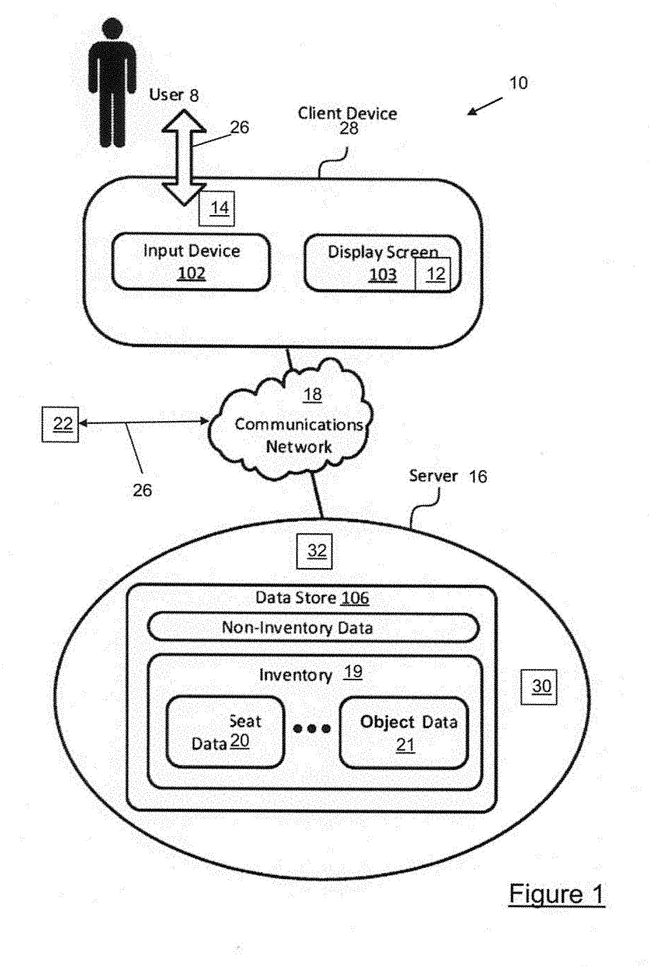

Seat: A seat is a physical seat or seat space/location that can be occupied by a user of the seat reservation system 10 (see FIG. 1). Therefore, a seat may be a piece of furniture, such as a chair. A seat, however, does not need to be a physical seat that someone sits on. For example, a seat can be a position at an outdoor location such as a pool, deck, beach, pool or beachside restaurant/café, cruise ships decks or any other outdoor physical space that can be reserved for the use of one or more people or entities. For illustrative purposes, the reservation system 10 is described herein in terms of physical seats in an outdoor place; however, such descriptions are not intended to be exemplary and not limiting.

Seat Relationship: Seat relationships are additional information regarding a seat in relation to one or more other seats and/or items/parameters in the spatial vicinity. An example of a seat relationship could be that one seat is next to, across from, or adjacent to another seat or table. Alternatively, a seat relationship may specify that a seat is by an exit, adjacent to a jukebox, has a view of a TV screen, has associated with the seat one or more environmental conditions such as degree of sun or shade, adjacency to other users of the system 10 having similar interests or requests (e.g. like sports minded, family type verses single, or the like).

Seat Group: A seat group is any grouping of one or more seats. For example, a seat group can include a table and one or more seats associated with the table. As another example, a seat group may be a physical space associated with one or more seats or tables. A seat group can be part of another seat group (as may be the case with an outdoor space containing several outdoor locations, each of which defines a seat group with the adjoining chairs/seats).

Reservation: A reservation is the allocation of one or more seats to one or more entities (such as people, users, or the like). A reservation can be for a start time that can be specified to any desired degree of precision. A reservation can be open-ended (no end time), or can have an unlimited duration, or can have a pre-established (limited) duration or a variable duration. In these cases, a queue may be created, where the next person in the queue can be seated at the next seat that becomes available. Additionally, reservations can be made to be recurring. For example, a seat in a specified location in an outdoor space can be reserved for a specific user for all days occurring in a particular week or other period of time.

Seat profile information is a way to define a location as a seat that can be reserved. The profile information can include a unique identifier that pertains only to the seat to which it is attached. The profile information can optionally include information regarding seat amenities, check-in requirements or procedures, check-out requirements or procedures, or the like. The profile information can also include proximity to objects (e.g. pool, washroom, bar, etc.) and/or characteristics about the seat such as but not limited to type of seat, characteristics of sun/shade with respect to objects (e.g. trees, buildings, umbrella) providing variability in the sun/shade throughout the day, etc.

User profile information can be user data known to the system 10 or otherwise supplied to the system 10 during the negotiation of a seat reservation request from the user. The user profile information can include data such as but not limited to: preferred neighbor type (e.g. families, single adults, etc.), preferred proximity to establishment amenities (e.g. change room, bar, restaurant, etc.), preferred degree of sun/shade coverage of the seat throughout the day, etc.

A proprietor of an establishment providing the outdoor seating for reservation by the users can be, for example, an operator of an outdoor restaurant, a municipality that provides seating reservations for public parks or campgrounds, a resort or vacation property with physical seats to be reserved, or the like. Those of skill in the art will recognize that the present invention may be used with a wide variety of facilities and/or proprietors not listed above.

A method for inventorying seating can provide the proprietor to catalog each seat and display those seats to any other entity or person using the system 10 via a visual seat representation 12 (see FIG. 1). For instance, a resort can inventory availability of a number of seats that people occupy during operational (e.g., business) hours, and then provide an application via the system 10 that is accessible by a mobile computing device to allow anyone to see and reserve the inventoried seats. People can then reserve a seat or a number of seats for a specific period of time in the outdoor space according to any number of desired parameters. Then, at or near the reservation time, people with reserved seats can check in to, occupy, and/or check out of the seats.

In the following description, several techniques and methods are presented for using Seat profile information and user profile information to facilitate steps by which seats may be inventoried, reserved, checked into, checked out of, and/or otherwise maintained according to the present invention. One skilled in the art will recognize that these various techniques and methods can be performed singly and/or in any suitable combination with one another.

### Overview of the System 10

As stated above, available solutions for outdoor public seating do not generally provide systems that allow proprietors and/or users to easily inventory, reserve, check in, occupy, and check out of a specific seat and/or multiple seats according to parameters that are specific to the outdoor environment adjacent to the seating. The following description provides numerous details, examples, and embodiments of the invention that help to solve one or more of the foregoing shortcomings. However, it will be clear and apparent to one skilled in the art that the invention is not limited to the embodiments set forth and that the invention can be adapted for any of several applications.

Referring to FIG. 1, inventory management and generation may be done through the use of an inventory application 14 (e.g. a client application of an inventory management server 16 or a device browser in communication with a network service of the server 16 over a communications network 18). The inventory application 14 can provide the user 8 to enter information about each seat, table, and/or seat group such as reservation options, amenities, location, applicable seat groups, usage costs, and other seat parameters associated with the seats in the outdoor space 19 stored as seat profile data 20 or the like. The inventory application 14 can have a text-based interface, and/or can use graphical elements to represent items, groups, and/or locations such as the seats, tables, seat groups, outdoor space 19, other adjacent objects or amenities, environmental aspects such as variability in sun/shade, and the like. The resulting inventory of the seat data 20 for the outdoor space 19 can be maintained, for example, in database form in a data store 106, either on the computing server 16 or on a server (e.g. establishment server 22 associated with the proprietor providing the physical outdoor space and seating 20) with which the computing server 16 communicates over the network 18. As such, it is the responsibility of the server 16 to receive seat reservation requests 26 either directly from the user 8 over the network 18 (i.e. via the user device 28 implementing the application 14) and/or indirectly via the establishment server 22 (e.g. directing requests received by the user 8 to the reservation server 16).

In some embodiments, the server 22 can also be used by the proprietor to reserve seats with the reservation server 16 (e.g. on behalf of a user or otherwise as a block reservation). Thus, a reservation application 14 can also be installed on the server 22 for interaction with the reservation server 16. In alternative embodiments, reservations can be made in a reservation application 14 by an entity besides the proprietor, such as the user 8 or group desiring to reserve one or more of the seats in the outdoor space inventory 19 of the data store. Thus, the reservation application 14 can be installed on one or more other computing devices 28 accessible to such entities. Such computing devices 22, 28 can be configured like the computing device 16 of the reservation system 10, or can have different configurations. Such computing devices 16, 22, 28 can communicate with one another over the network 18 to receive information about the inventory and/or transmit reservation information related to the reservation requests 26. Such reservation information can be used to update the inventory of the outdoor space 19, for example, by marking a seat data 20 for a particular seat to reflect it as “reserved” and making it unavailable for conflicting reservation requests 14 from other users 8 for the same day/dates/times.

The inventory application 14 mentioned above can provide inventory information in text and/or graphical form (e.g. in a representation 12 such as but not limited to a seat map). If desired, the inventory application 14 may show the seats, tables, seat groups, and/or other items graphically on a user interface or display screen 103. With such a graphical user interface, the reservation request 26 can be carried out directly through the graphical user interface 103, for example, by tapping or swiping with a finger over an icon representing one or more seats, tables, and/or seat groups provided in the seat representation 12. It is recommended that other details of the reservation can be accommodated in the graphical user interface 103 via the inventory application 14, such as but not limited to selecting reservation parameters offered by the reservation server 16, for example, items/amenities adjacent to the selected seat, degree of sun/shade experienced by the seat for selected periods of the day as per a sun/shade selector application 30 (further described below), and/or other reservation parameters available as reflected in the seat profile and/or user profile.

Once the user 8 with the reservation has arrived at the physical establishment, he or she can check into the reserved seats through the use of a check-in application provided. The check-in application can, according to one example, run on the computing device 8, 16, 22 that was used to make the reservation. Check-in can be done manually (for example, by selecting a “check-in” option in the check-in application). In the alternative, check-in can be performed automatically, for example, by detecting that the user 8 with the reservation is within a pre-established proximity of the establishment and/or the reserved seats.

### Example System 10 Architecture

According to various embodiments, the present system 10 can be implemented on any electronic device 16, 22, 28 equipped to receive, store, and present information. Such an electronic device can be, for example, a desktop computer, laptop computer, smartphone, tablet computer, server or the like. Each of the computing devices referenced above, including the computing devices 16, 22, 28 shown and described in connection with FIG. 1, can have any of these configurations.

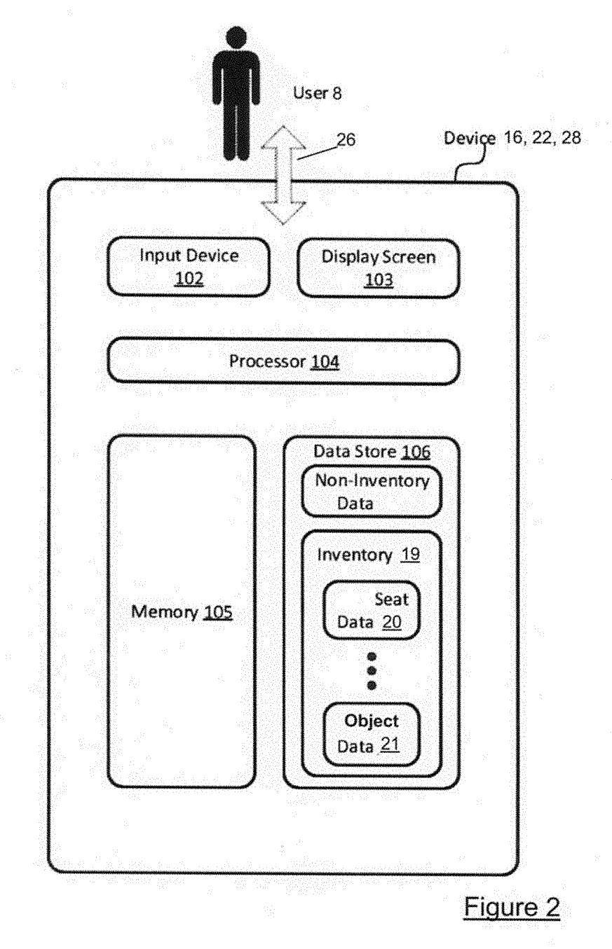

Referring now to FIG. 2, there is shown a block diagram depicting a hardware architecture for practicing the present system 10, according to one embodiment. Such an architecture can be used, for example, for implementing the techniques of the present invention in the computing device(s) 16, 22, 28, recognizing that preferably the data store 106 is implemented in the server(s) 16,22 rather than the user device 28. Computing device(s) 16, 22, 28 can be any electronic device equipped to receive, store, and/or present information, and to receive user 8 input in connection with such reservation/inventory related information.

In at least one embodiment, computing device 16, 22, 28 has a number of hardware components well known to those skilled in the art. Input device 102 can be any element that receives input from user 8, including, for example, a keyboard, mouse, stylus, touch-sensitive screen (touchscreen), touchpad, trackball, accelerometer, five-way switch, microphone, or the like. Input can be provided via any suitable mode, including for example, one or more of: pointing, tapping, typing, dragging, and/or speech. Data store 106 can be any magnetic, optical, or electronic storage device for data in digital form; examples include flash memory, magnetic hard drive, CD-ROM, DVD-ROM, or the like. In at least one embodiment, data store 106 stores information which may include non-inventory data (e.g. financial data, establishment information such as resort pictures, activities, etc.) and/or inventory 19 that can be utilized and/or displayed according to the techniques of the present system 10, as described below. In another embodiment, non-inventory data and/or inventory 19 can be stored elsewhere, and retrieved by computing device 16, 22, 28 when needed for presentation to user 8. Inventory data 19 can include data (e.g. seat profile information 20) regarding the seats, including seat data for a plurality of seats. Display screen 103 can be any element that graphically displays non-inventory data, inventory data 19, and/or the results of steps performed on non-inventory data and/or inventory data 19 to facilitate the user 8 to perform the activities for which the computing device 16, 22, 28 will be used. As described, this could include any or all of the steps of reservation request 26, inventory generation/management, reservation acceptance, reservation generation based on selected reservation parameters including interaction with the sun/shade selector application 30, checking in, and/or checking out for the seats, tables, and/or seat groups. Processor 104 can be a conventional microprocessor for performing operations on data under the direction of software, according to well-known techniques in order to implement the functionality of the inventory application 14, the sun/shade selection application 30, the reservation application 32 in communication with the user 8 and/or the establishment server 22 in receiving and processing the reservation requests 26. Memory 105 can be random-access memory, having a structure and architecture as are known in the art, for use by processor 104 in the course of running software implemented on the device(s) 16, 22, 28 and the associated functionality used to receive, process and provide results of the reservation requests 26. Data store 106 can be local or remote with respect to the other components of computing device 101. In at least one embodiment, computing device 101 is configured to retrieve data from a remote data storage device when needed. Such communication between computing device(s) 16, 22, 28 and other components can take place wirelessly, by Ethernet connection, via a computing network such as the Internet, or by any other appropriate means as provided by the network 18. This communication over the network 18 between the electronic computing devices 16, 22, 28 is provided as an example. In at least one embodiment, data store 106 is detachable in the form of a CD-ROM, DVD, flash drive, USB hard drive, or the like. Non-inventory data and/or inventory data 19 can be entered from a source outside of computing device 16, 22, 28 into the data store 106 that is detachable, and later displayed after the data store 106 is connected to computing device 16, 22, 28. In another embodiment, data store 106 is fixed within computing device 16, 22, 28.

For example, there can be an online/offline “rugged” infrastructure implementation for establishments with poor connectivity to the network 18. This proxy system embodiment can be responsible via the reservation system 32 for blocking groups of seats 50 from online reservation and holding them for local access using a pessimistic locking system. Locally booked seats 50 can be booked from within the establishment are then subtracted from the pool of local seats 50, which can inhibit conflicts with online reservation. When network 18 availability becomes active again, the seat 50 bookings can be synchronized online as negotiated using request/response communication between the reservation application 32 and the establishment server 22, such that the proxy embodiment negotiates another block of seats 50 for offline access. For establishments with no network 18 access, this process can be managed manually with a USB stick or other physical memory on a periodic (e.g. daily) basis.

Referring again to FIG. 2, there is shown a block diagram depicting a hardware architecture for practicing the present invention in a client/server environment, according to one embodiment. Such an implementation may use a “black box” approach, whereby data storage and processing are done completely independently from user input/output. An example of such a client/server environment is a web-based implementation, wherein client device 28 runs a browser that provides a user interface 103 for interacting with web pages and/or other web-based resources from server 16, 22. Display screen 103 of the user interface can be any element that graphically displays non-inventory data, inventory data 19, and/or the results of steps performed on non-inventory data and/or inventory data 19 to facilitate the user 8 to perform the activities for which the computing device 28 will be used. As indicated, this could include any or all of the steps of, reservation request receipt, inventory management/generation, reservation generation, checking in, and/or checking out for the seats, tables, and/or seat groups.

Non-inventory data, data, and/or inventory data 19 can be presented and/or manipulated as part of such web pages and/or other web-based resources, using known protocols and languages such as Hypertext Markup Language (HTML), Java, JavaScript, and the like. Alternatively, non-inventory data and/or inventory data 19 can be presented and/or manipulated from within one or more mobile device applications (“apps”), which may run on iOS, Android, Blackberry, Windows Mobile, or any other known mobile computing platform. In this application, reference to a computing device is intended to include devices such as the client device 28 in addition to the various computing devices 16,22 described in connection with FIG. 2.

Client device 28 can be any electronic device incorporating an input device 102 and/or display screen 103, such as a desktop computer, laptop computer, personal digital assistant (PDA), cellular telephone, smartphone, music player, handheld computer, tablet computer, kiosk, game system, or the like. Any suitable type of communications network 18, such as the Internet, can be used as the mechanism for transmitting data between client device 28 and server 16, 22, according to any suitable protocols and techniques. In addition to the Internet, other examples include cellular telephone networks, EDGE, 3G, 4G, long term evolution (LTE), Session Initiation Protocol (SIP), Short Message Peer-to-Peer protocol (SMPP), SS7. Wi-Fi, Bluetooth, ZigBee, Hypertext Transfer Protocol (HTTP), Secure Hypertext Transfer Protocol (SHTTP). Transmission Control Protocol/Internet Protocol (TCP/IP), and/or the like, and/or any combination thereof. In at least one embodiment, client device 28 transmits requests for reservation associated data via communications network 18, and receives responses from server 16, 22 containing the requested reservation associated data. It is recognized that reservation associated data is in the context of seating reservations for seat(s) in the outdoor space inventory 19.

In this implementation, server 16,22 is responsible for data storage and processing, and incorporates data store 106 for storing non-inventory data and/or inventory data 19. Server 16 can include additional components as needed for retrieving data and/or inventory data 19 from data store 106 in response to requests from client device 8 and/or the establishment server 26. In at least one embodiment, non-inventory data and/or inventory data 19 are organized into one or more well-ordered data sets, with one or more data entries in each set. Data store 106, however, can have any suitable structure. Accordingly, the particular organization of non-inventory data and/or inventory data 19 within data store 106 need not resemble the form in which non-inventory data and/or inventory data 19 are displayed to user 8. In at least one embodiment, an identifying label (e.g. unique identifier of the establishment, the outdoor space, and/or the seats) is also stored along with each data entry, to be displayed/included along with each data entry appropriate to the receipt and processing of the reservation requests 26. In at least one embodiment, non-inventory data and/or inventory data 19 can be organized in a file system within data store 106. Appropriate indexing can be provided to associate particular documents with particular quantitative data elements, reports, other documents, and/or the like. Non-inventory data and/or inventory data 19 can include any of a wide variety of data structures known in the database arts.

### Representation 12

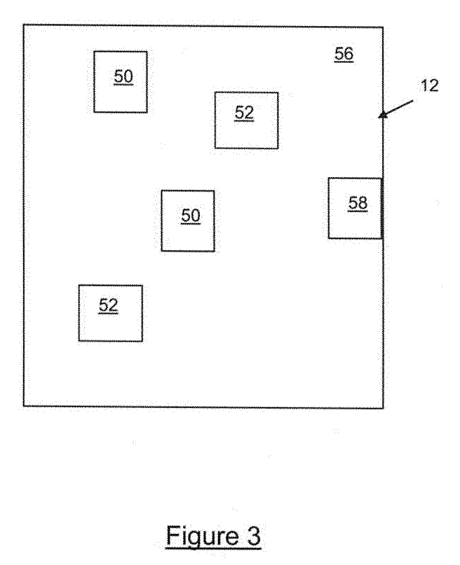

Referring to FIG. 3, shown is an example representation 12 that can be provided to the user device 28 by the server 16 in response to processing of the seat reservation request 26. For example, the representation 12 can include a map of all the seats 50 and adjacent objects 52 (e.g. bar, trees, umbrellas, buildings, ocean, pool, etc.) of the outdoor space 54, recognizing that the seats 52 and/or adjacent objects 52 can be stored representationally in the seat data 20 (e.g. seat profile information) in the data store 106. As further described below, operation of the sun/shade selector application 30 can be used to provide sun/shade indicators 56 (e.g. areas of sun/shade covering the outdoor space 19 adjacent to as well as overlapping with the physical position of the seat(s) 50 within the physical outdoor space 56). A sun/shade selector 58 can be included in the representation 12 provided to the user 8, as desired, whereby activation of the selector 58 could launch the sun/shade selector application 30 via the user interface 103 of the client device 28.

As such, via the representation 12 (e.g. provided as one or more web pages by the server 16), the graphical user interface 103 can have a seat information section that indicates the unique identifiers for the seats 50. A seat name section can facilitate the user 8 to easily provide a name for the desired seat 50, which can be stored as the seat name in the seat data 20. Free-form text entry can be used to select the seat name. A seat type section can facilitate the user 8 to select what type of seat 50, which can be stored as a seat type in the seat data 20. A dropdown menu or the like can be used to permit easy user 8 selection of the seat type or other available parameters of the seat available in the seat profile data 20 associated with the seats 50 shown in the representation 12. An image (or diagram) of the seats and/or objects 52 can be presented by the graphical user interface 103, and can be stored as a seat picture in the seat data 20. The image can be associated with the unique identifier for outdoor space 56 and can be static or dynamically updated to reflect seat 50 availability/occupancy in response to the seat reservation request 28 as well as any interaction (e.g. selections) provided by the user via the user interface 103 to the reservation server 16. One example of dynamic updating of the seat map image (e.g. the representation 12 content) can be in response to operation of the sun/shade selection application 30. Another example of dynamic updating of the representation 12 content can be to indicate seats pertaining to parameter selection (or matching by the system server 16) pertaining to the reservation request 26.

A seat amenities section can enable the user 8 to select the amenities applicable for the seat 50. The selections may be stored as seat amenities in the seat data 20. The seat amenities section can have multiple checkboxes representing amenity options that can be selected for each seat 50. The user 8 may simply mark the boxes for the amenities possessed by the seat 50. In at least one embodiment, a free-form text field (not shown) or other user interface element can be used for specifying amenities. Alternatively, the reservation application 32 can match the parameters (e.g. selected amenities) included in the reservation request 26 with available seats 50 having those parameters as part of their seat data 20 (i.e. seat profile).

As such, the inventory data 19 can be generated and displayed to the user 8 in the representation 12 containing the seats 50, tables/objects 52, and/or seat groups for which reservation request 26 pertains to (e.g. the reservation request would have an identifier of the seat space 56 represented by the inventory data 19 associated with a particular establishment). This can facilitate visualization of the seats 50, objects 52, and/or seat groups by the user 8. For example, the seats 50, objects 52, and/or seat groups displayed in the representation 12 can be arranged, for example, to match their actual or desired layout in the physical outdoor space 56. If reference seat relationship, current seat relationship 424, reference seat location, current seat location, reference seat group, and/or current seat group are included in the representation 12 as processed by the reservation application 32, all or part of this task may be performed automatically by the application 32. The reservation application 32 can simply use the received position data, seat/object relationships, and or seat groupings present in the data 19,20 to suggest positions of the seats 50 matching parameters of the reservation request 26. It is recognized that the parameters of the reservation request 26 can be received at one time or sequentially as the user 8 interacts with the representation 12 as delivered by the server 16 to the user interface 103 (via the inventory application 14). For example, each seat 50 displayed in the seating display of the representation 12 can be shown along with its seat name. The available seats 50 in the seating display can be shown in a highlighted state (or other visually distinguished way via colour or otherwise from the occupied seats 50) to indicate that it is currently available or otherwise selected. Further, information below the seating display can pertain to other aspects or parameters of the seats 50 in the seating display.

As such, it is recognized that the graphical user interface 103 can display, in response to receiving the representation 12 (generated by the server 16 in view of the parameters of the reservation request entered by the user 8), any results of the request criteria, either statically and/or interactively as representation 12 content updates. The criteria can be such as: a specific location or search area of the outdoor space 56; a number of adjacent seats 50 or parameters associated with those adjacent seats 50 (e.g. characteristics of the adjacent seat occupants); a number of seats 50 associated with an adjacent object 52 or seat group; seats 50 that are related to each other but not necessarily adjacent to each other (i.e., across from each other, etc.); and/or seats 50 with certain amenities including sun/shade degree by example. The representation 12 can include a seating display that shows, for example, a plan view depicting the seats 50 that have been made available for reservation. The seating display of FIG. 3 depicts, by way of example, seats 50 near objects 52 (e.g. bar, pool). The seating display can optionally be interactive, and can thus allow the user 8 to tap or otherwise select one or more seats 50, objects 52, and/or seat groups from the seating display for reservation. The selected seats 50, objects 52, and/or seat groups may be highlighted or otherwise visually indicated in the seating display. If desired, the availability time/date for each seat 50 can be shown in the seating display. Additionally or alternatively, each seat 50 or an associated icon or text may be color-coded to indicate the associated status and/or availability time/date. For example, seats 50 with an availability time/date matching the request 26 be colored green, and seats 50 with an availability time/date closely but not quite matching the request be colored yellow. Seats 50 that are occupied and thus not matching the request 26 can be colored red. Any other suitable color-coding scheme can be used, using a predefined matching threshold to determine the degree of matching between the request 26 data (and/or user profile) and the seat profile information of the seat data 20. It is recognized that as seats 50 are reserved and/or become available, the contents of the seat data 20 would be updated by the reservation application 32 to reflect this change in seat status. The representation 12 can also have a reservation details section that provides the user 8 with information regarding the reservation that has been selected. In the exemplary embodiment, the reservation details section can indicate that the seat 50 by its changed color to indicate the reserved time/date status.

In some embodiments, the representation 12 can display advertisements, promotions, incentives, rewards, etc. that can be redeemed by the user 8. These can include discounts or other promotions in connection with seats 50 available for reservation. For example, the user 8 can be incentivized to select less-popular seats 50 and/or a larger number of seats 50 by discounts or establishment promotions that display in connection with less popular seats 50 and/or seat groups in the seating display.

Referring again to FIGS. 1 and 3, it can be seen that the operator of the establishment is in communication with the reservation server 16 in order to provide for remotely located users 8 (including those staying on premises of the establishment) to reserve specific seating for specific outdoor spaces 56. By doing so, the user 8 can initiate those certain actions necessary to display an internet web site to the users 8, such that a prospective user for the outdoor space 56 logs onto or otherwise access the reservation server 16 (either directly and/or indirectly via the establishment server 22) and acquires access to the reservation application 32 which implements the reservation request 26 processing. Upon first contact by the prospective user 8, an inquiry 26 is directed to the appropriate database 106, which can be located concurrent with the primary server 16 hosting the reservation application 32 or can be located remotely, such as at the physical location of the establishment, asking for a return of information to the prospective user 8 of all appropriate information contained therein relative to the inquiry 26. The prospective user 8 indicates desired seat or seats 50 (or characteristics thereof via general request parameters) through conventional computer input means and directs that information back to the server 16 hosting the code necessary to the implementation of the reservation application 32. Upon contact, the server 16 again makes an appropriate database 106 query and returns to the prospective user 8 all pertinent information relating to the seat selection, such as which seats 50 are still available for the chosen outdoor space 56 and associated seat parameters. The prospective user 8 is then presented with a representation of all then available seating 50 for the selected outdoor space 56 (recognizing that the establishment could have a plurality of outdoor spaces 56 available to the user 8). From this representation 12, the prospective user 8 makes a selection of a seat or seats 50 by indicating such through a mouse click, keyboard entry or other means, such as but not limited to a touch screen. Simultaneously, the server 16, through the coding necessary to implement the reservation application 32, creates a user identification that is used to associate this potential user 8 with this later selection and permit system use by multiple simultaneous users 8. Once the user 8 has made the seat 50 selection, the user 8 is asked for payment information. That payment information can be processed through conventional internet or other electronic means and once the information and payment are verified, the user 8 information, is made permanent as a reservation and the seat or seats 50 selected are removed from inventory data 19 and blocked from duplicate sale, both graphically when presented to the next prospective user 8 and in the database 106 where information 20 for accounting and administrative purposes is retained. Upon verification of the user's payment information, the user 8 receives a confirmation of the reservation transaction containing all appropriate reference information for records of the seat(s) reservation.

Payment for the seat 50 selection(s) can be accommodated by the reservation server 16 by a number of different methods involving a number of different payment parameters, as desired. For example, the method of renting the seats/spaces can include a payment/reservation formula that may be simple or complicated. For example, the formula could include an algorithm or variables such as occupancy rates, weather, or time of year as determinators on how the reservation is made (what user information is required) and what the ultimate reservation amount would be. Further, other payment/reservation parameters could be: resort occupancy, proximity to pool, proximity to beach, seasonality (high season vs low season), type of chair (i.e. there could be cushions or no cushions), proximity to a desired location (near the DJ), duration of rental, number of rentals (rent 4 and get a discount), demand (could do an auction process based on demand), and other variables that could be used to determine price

### Sun/Shade Application 30

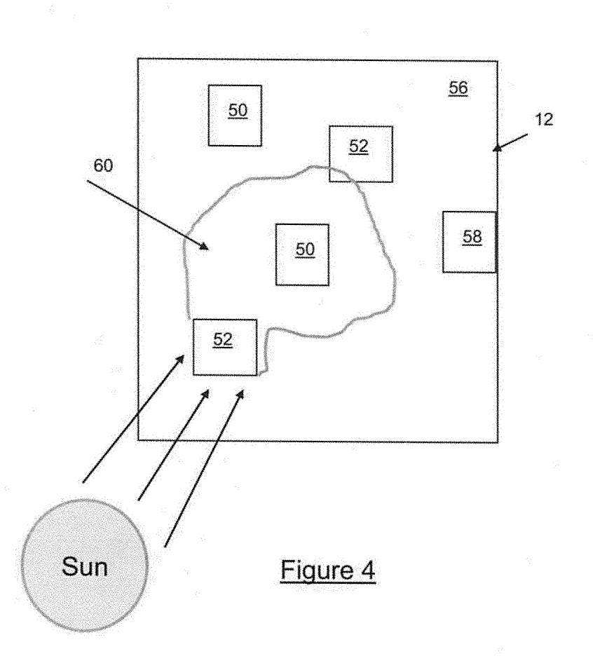

Referring to FIG. 4, implementation of the sun/shade application 32 can be facilitated by displaying on the representation 12 a time of day selector 60 (e.g. a time slider), such that the user 8 can dynamically change a time of day setting in order to obtain an interactive display of the seating 50 showing sun/shade regions 60 based on positional separation of the object 52 in relation to the seat 50 and an angle of the sun experienced by the outdoor space 56 at that time of day selected. It is recognized that the angle of the sun at a particular geographical location on the earth is dependent upon the time of day and the time of year of that day.

As such, the position of the Sun in the sky is a function of both time and the geographic coordinates of the object 52 in the outdoor space 56 on the surface of the Earth. As the Earth moves around the Sun during the course of the year, the Sun appears to move with respect to the fixed stars on the celestial sphere, along a path called the “ecliptic”. The Earth's rotation about its axis causes the fixed stars to move in the sky in a way that depends on the observer's geographic latitude. The time when a given fixed star crosses the observer's meridian depends on the geographic longitude. In general, to find the Sun's position (i.e. angle) for a given object 52 at a given time, one may therefore proceed by calculating the Sun's position in the ecliptic coordinate system, convert to the equatorial coordinate system, and convert to the horizontal coordinate system, for the objects 52 local time and position, for example. Also knowing the height and breadth of the object 52, in combination with the distance between the object 52 and the seat 50 as well as the orientation between the seat 50 and object 52 in respect to the determined angle of the sun provides for calculation of the sun/shade regions 60 present in the outdoor space 56 as a consequence of the object 52 being in the path of the sun and therefore intercepting or otherwise blocking the sunlight from reaching the adjacent seat(s) 50 in the outdoor space 56. For example, the regions 60 can represent the absence of direct sunlight otherwise referred to as a shadow cast by the object 52 that is experienced by the adjacent seat 50 as shade. Alternatively, the regions 60 can represent the presence of direct sunlight that is not affected by the absences of direct sunlight (shadows cast by the objects 52) as experienced by the adjacent seat 50 as sunlight. For example, the regions 60 can represent sunlit regions 60 for the specified time/date of the outdoor space 56 at a particular geographical position (e.g. latitude and longitude), for those users 8 interested in seats 50 suitable for tanning. For example, the regions 60 can represent shade regions 60 for the specified time/date of the outdoor space 56 at a particular geographical position (e.g. latitude and longitude), for those users 8 interested in seats 50 suitable for avoiding tanning or overexposure to the sun. As such, shade regions 60 can be referred to those regions 60 experiencing the blocking of sunlight (in particular direct sunshine) by any object 52 (having a defined height and breadth as stored in the inventory data 19 as object data 21), and also the shadow created by that object 52. Shade also consists of the colors grey, black, white, etc. It may refer to blocking of sunlight by the object 52, e.g. roof, a tree, an umbrella, a window shade or blind, structure, or other objects. As such, sunlit regions 60 can be referred to those regions 60 experiencing the exposure to sunlight (in particular direct sunshine) as not blocked by any object(s) 52 (having a defined height and breadth as stored in the inventory data 19 as object data 21), and also avoiding the shadow created by that object(s) 52.

In terms of generating the height and breadth data 21 in the database 106, as reflected by the sun/shade regions 60 in the representation 12, there can be a number of embodiments for such. In one embodiment, outdoor area 56 map construction (i.e. generation of the representation 12 to include the seats 50, the objects 52 and the regions 60) can be done via manual mapping, such that a graphic artist can visit the outdoor area 56 in person to manually graph the outdoor area 56 in 3D using a 3D animation tool. From there, these graphs can be stored in the data store 106 and associated with the outdoor area 56, such that the sun/shade application 32 can use pre-rendered various different sun positioning images for shading, so that the devices 28 can interface with the sun-dial seat selector 58 as described. This rendering technique can be done in combination with Semi-automatic mapping or Fully-automatic mapping. In Semi-automatic mapping a mechanical drone can be deployed over the outdoor area 56 while it is not in use and a combination of IR cameras and various other devices can be used to detect objects 52 and render a 3D map from all required angles (in order to collect the height and breadth data of the objects 52). From there, the textures relating to the height and breadth data 21 stored in the data store 106 can be automatically applied by the sun/shade application 30 and mapped to the 3D objects, and a shading algorithm applied to depict the shadows that would be cast throughout the day for each season based on time/date information supplied by the user 8 in the reservation request 26. An algorithm of the sun/shade application can be applied to remove natural shadows as a result of current lighting conditions and apply its own synthetic shading on top of the new 3D model. In terms of fully-automatic mapping, Google Earth renditions (or other satellite based earth surface image renditions) can be pulled automatically from our web service (e.g. the reservation application 32). From there, the object height and breadth data is scraped into a data 21 format that our service can transform, and various automated manipulations are done so that it is stored as the object data 21. These calculations can include calculating, based on the geographic location of the outdoor area 56, the position of the sun throughout each season, and the shading required for objects 52 detected in the image of the outdoor area 56. Further, it is recognized that the reservation application 32 can manage requests from different time zones through an algorithm that translates requests based on Coordinated Universal Time (UTC) as a baseline to render the correct shading/sun regions 60 based on the position of the sun.

Further to the above, it is recognized that the generation of the outdoor area 56 to include calculated regions 60 based on object data 21, relative positional data between the seats 50 and the objects 52, and time/date data provides, a number of different techniques can be utilized as per above. For example in Vector-based Image Tweening, this can include a) perception of 3D shadow-casting presented through a series of vector images of the outdoor area 56, b) each series of vector images can be compressed together rather than individually to take advantage of repetition in the image format, (providing for faster download of the app/initial synchronization), c) algorithm of the sun/shade application 30 can select the appropriate series of images based on the season and geo-coordinates of the outdoor area 56, d) the user 8 slides finger along intuitive “sun dial seat selector” control 58 of the representation 12 to view shading/sun regions 60 imposed on the outdoor area 56 in relation to the adjacent objects 52 and seats 50, e) algorithm can determine source and destination images based on finger position and can build an animation (e.g. series or sequence of successive images for the representation 12) with ease-in and ease-out between the images, f) algorithm can determine a desired frame rate of the sequential images based on device performance and other settings as per the sequential time/date settings selected by the user in operation of the sun/shade sector 58, and g) images can be displayed in the representation 12 of the outdoor area 56 in rapid succession to simulate 3D shadow casting with fast performance, even on older devices.

For example using drone mapping, the object data 21 can be facilitated by a) a new map slot is created within the application 30, assigned a set of geographic coordinates, and linked to a selected drone, b) the drone can be configured with a pre-set perimeter of the outdoor area 56 and programmed navigate the space to capture every angle of the outdoor area 56, c) a 2D object model is built by the sun/shade application 30 based on the drone data and textured based on returned images, d) a 3D object model can be extrapolated through a combination of image analysis, edge detection, and hardware/scanner read-outs by the sun/shade application 30, e) textures can be applied to the 3D model automatically, f) model and textures can then be manipulated manually with tools (optional) to finish the product, and f) final map is processed and compressed for Vector-based Image Tweening as per above.

For example, in a seasonal Shadowcasting Algorithm, the object data 21 can be facilitated by a) geographic coordinates entered and applied to a 3D map for the outdoor area 56, b) sun position and trajectories from sunrise to sunset can be calculated based on the Earth's axis at 4 different seasons, c) 3D modelling software of the application 30 can be automated to generate shading at each specified minute of the day, and d) images can be extracted, decimated, compressed, and sent for vector-based image tweening as per above.

For example, in terms of A/R Course Plotting once the reservation is completed and the user 8 is subsequently physically present in the for the outdoor area 56, the user can be facilitated to their reserved seat by a) user holds up mobile device to the outdoor area 56, b) application 14 of the mobile device recognizes tags/indicators to show available seats 50, c) algorithm of the application 14 loads floor plan for current for the outdoor area 56 to accommodate seats 50 that are currently out of the camera's view, d) a virtual pathway or other digital beacon is overlaid on the screen to direct the user 8 to their seat 50, and e) optionally, the user 8 can see reserved and unreserved seats 50 and reserve directly from the A/R interface, as desired.

We claim:

1. A method for determining a reservation booking of a chair location positioned in an outdoor environment, the method implemented by a computer processor operating on a set of instructions stored in memory to:
receive a reservation request from a user over a communication network, the reservation request including a unique identifier for an establishment providing the outdoor environment and a reservation date/time;
send a map of the outdoor environment over the communication network including a plurality of chair locations, each chair of the plurality of chairs having a respective indicator indicating whether said each chair is available or booked for the reservation time, the map including exterior features of the outdoor environment positioned in relation to the plurality of chair locations;
receive a selection over the communication network of a desired chair location displayed on the map, the desired chair selected from the plurality of chair locations, and
send the reservation booking over a communication network to the user, the reservation booking including a chair location identifier for the reservation time.

2. The method of claim 1, wherein the reservation time is for a time period of a specified date or for a plurality of time periods for a plurality of specified dates.

3. The method of claim 1 further comprising the step of updating the respective indicator in real time between said receive the reservation request and said receive the selection; wherein a booking status of one or more of the plurality of chair locations is changed.

4. The method of claim 1; wherein the reservation request is associated with a separate accommodation reservation between the user and the establishment.

5. The method of claim 1; wherein the exterior features include parameters associated with time of day (for example sun/shade, relative location to a pool, restaurant, etc.).

6. The method of claim 1 further comprising the steps of:
access a user profile of the user, the user profile having a plurality of user preferences associated with chair location (e.g. next to a certain type of person, in the sun/shade, isolated, in pedestrian traffic, etc);
compare one or more of the plurality of user preferences with corresponding parameters assigned to each said chair location; and
include in the map matching chair locations based on said compare.

7. The method of claim 1 further comprising the step of: receive from the user feedback information of the reservation booking and store the feedback information in a user profile of the user, the user profile having a plurality of user preferences associated with chair location.

8. The method of claim 1 further comprising the step of: send the reservation booking to the establishment and update the respective indicator of the chair location assigned to the chair location identifier.

9. The method of claim 1 further comprising the steps of:
present an interactive sun/shade display tool to the user, the interactive sun/shade display tool having a control operable by the user to vary a time of day and associated amount of sunlight experience by each said chair location;
receive the time of day from the user based on operation of the interactive sun/shade display tool; and
update the map to include visual indication of said amount of sunlight for each of chair location of the plurality of chair locations in the outdoor environment.

10. The method of claim 9, wherein said amount of sunlight is part of the exterior features.

11. The method of claim 10, wherein the interactive sun/shade display tool uses the time of day, latitude and longitude of the environment, and vertical dimensions of structures adjacent to the plurality of chair locations in order to determine said amount of sunlight.

12. The method of claim 11, wherein the structures include buildings and foliage.

13. The method of claim 7; wherein an amount of sunlight associated with the user is associated as the feedback information and stored in a user profile of the user as a user preference associated with chair location, the user profile having a plurality of user preferences associated with chair location.

14. The method of claim 7 further comprising the steps of:
access the user profile of the user;
compare the amount of sunlight with corresponding parameters assigned to each said chair location; and
include in the map matching chair locations based on said compare.
